(19) United States
(12) Patent Application Publication
(10) Pub. No.: US 2025/0315595 A1
(43) Pub. Date: Oct. 9, 2025

(54) SYSTEMS AND METHODS FOR CONTEXTUALIZING DATA

(71) Applicant: Slope Tech, Inc., San Francisco, CA (US)

(72) Inventors: Alexander WU, San Carlos, CA (US); Jingchao Huang, Lafayette, CA (US); Bryant Chen, Oakland, CA (US); Andre Frederico Cavalheiro Menck, Lafayette, CA (US); Damian Ancukiewicz, San Mateo, CA (US)

(21) Appl. No.: 19/098,591

(22) Filed: Apr. 2, 2025

Related U.S. Application Data
(60) Provisional application No. 63/575,904, filed on Apr. 8, 2024.

(51) Int. Cl. G06F 40/151; G06F 40/279

(52) U.S. Cl. CPC G06F 40/151; G06F 40/279

(57) ABSTRACT

A system configured for contextualizing data. The system may receive first data, and may transform the first data into modified first data. The system may train a first language model to identify first feature(s) from the modified first data to create a trained first language model. The system may receive second data, and may transform the second data into modified second data. The system may identify, via the trained first language model, the first feature(s) from a first portion of the modified second data. The system may dynamically map the first portion of the modified second data to one or more first categories. The system may generate a first customized report based on one or more of the modified second data, the first feature(s), the one or more first categories, or combinations thereof.

### CROSS-REFERENCE TO RELATED APPLICATIONS

The present application claims priority under 35 U.S.C. § 119 to U.S. Provisional Patent Application No. 63/575,904, filed Apr. 8, 2024, the entire contents of which are fully incorporated herein by reference in their entirety.

### FIELD

The disclosed technology relates to systems and methods for contextualizing data. Specifically, this disclosed technology relates to contextualizing data using a language model trained to identify features from modified data.

### BACKGROUND

Collecting and contextualizing user-specific data is important to providing users, such as businesses, with unique data insights and real-time services. For example, bank transactions are critical for building automated and real-time underwriting systems that do not rely on human- or customer-reported financials. However, in order to provide such systems, the user-specific data must be deciphered, aggregated, and contextualized in such a way as to treat each individual user as unique to others.

Accordingly, there is a need for improved systems and methods for contextualizing data. Embodiments of the present disclosure may be directed to this and other considerations.

### SUMMARY

Disclosed embodiments may include a system for contextualizing data. The system may include one or more processors, and memory in communication with the one or more processors and storing instructions that, when executed by the one or more processors, are configured to cause the system to contextualize data. The system may receive first data including one or more first text threads. The system may transform the first data into modified first data by inserting a grammatical pattern into the first text thread(s), and inserting one or more text phrases into the first text thread(s) adjacent to the grammatical pattern. The system may train a first language model to identify one or more first features from the modified first data to create a trained first language model. The system may receive second data including one or more second text threads. The system may transform the second data into modified second data by inserting the grammatical pattern into the second text thread(s). The system may identify, via the trained first language model, the first feature(s) from a first portion of the modified second data. The system may dynamically map the first portion of the modified second data to one or more first categories. The system may generate a first customized report based on one or more of the modified second data, the first feature(s), the one or more first categories, or combinations thereof.

Disclosed embodiments may include a system for contextualizing data. The system may include one or more processors, and memory in communication with the one or more processors and storing instructions that, when executed by the one or more processors, are configured to cause the system to contextualize data. The system may receive first data. The system may transform the first data into modified first data. The system may identify, via a first language model, first feature(s) from a first portion of the modified first data, wherein the first language model is trained to identify the first feature(s) from the modified first data based on the modified first data comprising the first data and a grammatical pattern inserted into the first data. The system may dynamically map the first portion of the modified first data to one or more first categories. The system may generate a first customized report based on one or more of the modified first data, the first feature(s), the one or more first categories, or combinations thereof.

Disclosed embodiments may include a method for training a first language model to identify first feature(s) from modified first data. The method may include collecting first data comprising one or more text threads. The method may include transforming the first data into the modified first data by inserting a grammatical pattern into the text thread(s), and inserting one or more first text phrases into the text thread(s) adjacent to the grammatical pattern. The method may include creating a first training set comprising the first data and the modified first data. The method may include training the first language model using the first training set.

Further implementations, features, and aspects of the disclosed technology, and the advantages offered thereby, are described in greater detail hereinafter, and can be understood with reference to the following detailed description, accompanying drawings, and claims.

### BRIEF DESCRIPTION OF THE DRAWINGS

Reference will now be made to the accompanying drawings, which are not necessarily drawn to scale, and which illustrate various implementations, aspects, and principles of the disclosed technology. In the drawings:

FIGS. 1A-1B are a flow diagram illustrating an exemplary method for performing data contextualization, in accordance with certain embodiments of the disclosed technology.

FIG. 2 is a flow diagram illustrating an exemplary method for training a language model to identify feature(s) from modified data, in accordance with certain embodiments of the disclosed technology.

FIG. 3 is a block diagram of an example feature identification system used to contextualize data, according to an example implementation of the disclosed technology.

FIG. 4 is a block diagram of an example system that may be used to perform data contextualization, according to an example implementation of the disclosed technology.

### DETAILED DESCRIPTION

While collecting and contextualizing user-specific data is important to providing users, such as customers or businesses, with unique data insights and real-time services, until now, there has been no system that can do this reliably and to the precision necessary to power certain customer support processes, such as credit underwriting, or to programmatically construct user-specific reports, such as financial reports (e.g., income and cash flow statements). Further, traditional data contextualization systems and methods typically require pulling data directly from user accounts, and take a generalized approach to aggregating and labeling such data, resulting in data management and support that is agnostic to particular users or their respective needs. As such, data tends to be tagged and labeled in a fixed, unreliable, and/or inaccurate fashion, and the overall systems can present predictability and scalability challenges.

Additionally, certain user-specific data can be difficult to understand. For example, transaction data is typically not written in any one language, but is expressed as its own language, for example strings of various letters, numbers, characters, symbols, etc. Further, otherwise equivalent transaction data can be expressed in a variety of ways across different users or entities, and can be complex, for example, having components that represent different counterparties, channels, money flow intermediaries (e.g., PayPal®, Zelle®), etc. Finally, even identically expressed transactions may categorically mean different things to different businesses (e.g., a wire payment from Mattress Firm may be a purchase rebate for one business and revenue for another) which illustrates the limitations of a static labeling system. Accordingly, examples of the present disclosure may provide for collecting and contextualizing user-specific data in a dynamic, accurate, concise, and deterministic fashion, such that this data can be aggregated and used to generate user-specific data reports.

Disclosed embodiments may employ language models, among other computerized techniques, to aid in identifying customer-specific features from a set of data. Language models are a unique computer technology given their pre-trained knowledge of the world, their ability to reason, and their ability to extract meaning from unstructured data. Language models can also be further trained (or “fine-tuned”) to complete domain-specific tasks, and to make inferences or decisions that apply their pre-trained world knowledge and reasoning. These techniques may help to improve database and network operations. For example, the systems and methods described herein may train and utilize, in some instances, language models, which are necessarily rooted in computers and technology, to identify certain user-specific features from transaction data. These language models may first be fine-tuned using a Low-Rank Adaptation (LoRA) algorithm, as described in Hu, E. et al. (2021). LoRA: Low-Rank Adaptation of Large Language Models, which is fully incorporated herein by reference. Using a language model and a computer system configured in this way may allow the system to provide data reports, such as financials, that are unique to individual users.

This is a clear advantage and improvement over prior technologies that may not be able to contextualize user-specific data with similar predictability or scalability. The present disclosure solves this problem by using a language model trained to label transaction data quickly and efficiently in order to identify certain user-specific features from the data. Furthermore, examples of the present disclosure may also improve the speed with which computers can identify such features and thus generate user-specific reports. Overall, the systems and methods disclosed have significant practical applications in the data analysis and contextualization fields because of the noteworthy improvements of speed, accuracy, and reliability, which are important to solving present problems with this technology.

Some implementations of the disclosed technology will be described more fully with reference to the accompanying drawings. This disclosed technology may, however, be embodied in many different forms and should not be construed as limited to the implementations set forth herein. The components described hereinafter as making up various elements of the disclosed technology are intended to be illustrative and not restrictive. Many suitable components that would perform the same or similar functions as components described herein are intended to be embraced within the scope of the disclosed electronic devices and methods.

Reference will now be made in detail to example embodiments of the disclosed technology that are illustrated in the accompanying drawings and disclosed herein. Wherever convenient, the same reference numbers will be used throughout the drawings to refer to the same or like parts.

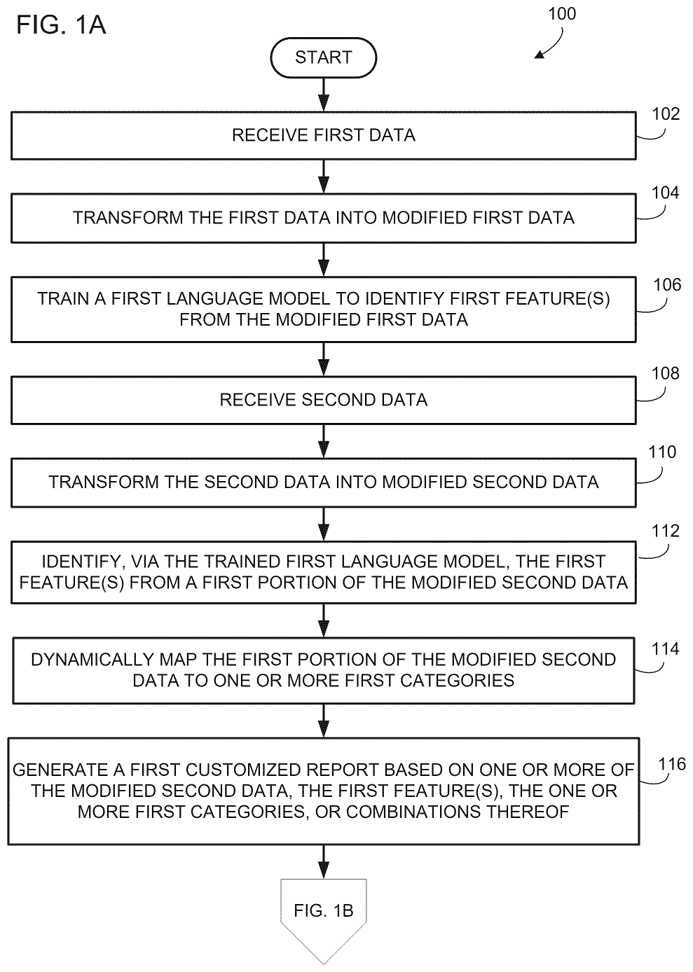

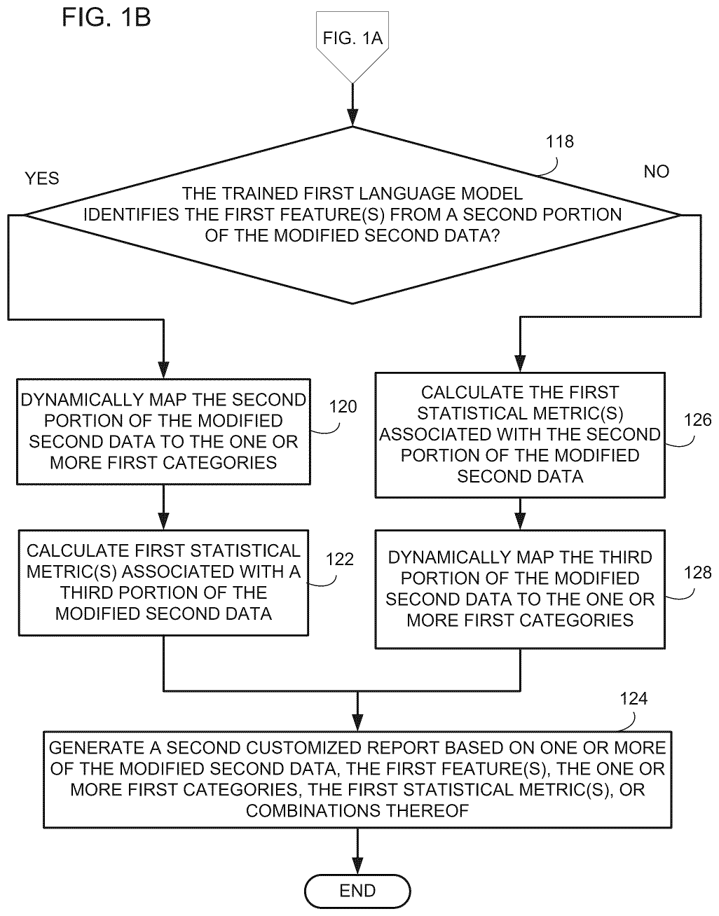

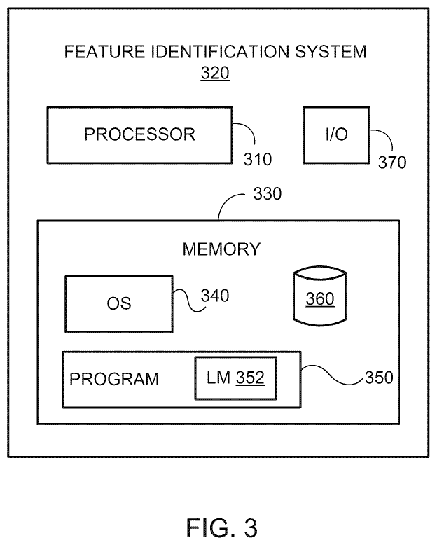

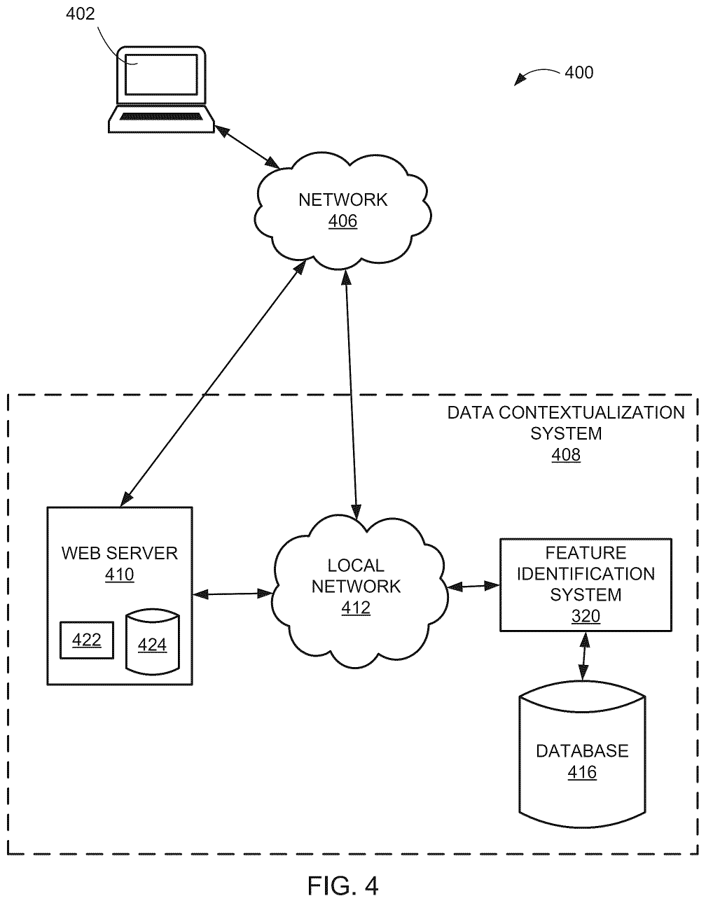

FIGS. 1A-1B are a flow diagram illustrating an exemplary method 100 for contextualizing data, in accordance with certain embodiments of the disclosed technology. The steps of method 100 may be performed by one or more components of the system 400 (e.g., feature identification system 320 or web server 410 of data contextualization system 408, or user device 402), as described in more detail with respect to FIGS. 3 and 4. It should be understood that certain embodiments of the disclosed technology may omit one or more blocks as being optional.

In block 102 of FIG. 1A, the system (e.g., data contextualization system 408) may receive first data. In some embodiments, the first data may include transaction data associated with one or more users, such as entities, merchants, businesses, etc. The system may continuously receive the first data based on a real-time connection with each of the user(s). The system may continue receiving the first data indefinitely until it loses such real-time connection to the transaction data, such as if a user closes an account (e.g., a bank account), or changes its account login credentials (e.g., in which a new connection must be established), or if some other technical issue causes the connection to be lost. In some embodiments, the system may receive the first data via an application programming interface (API) and/or by monitoring a component of system 400 (e.g., web server 410) to determine whether the component has received or collected the first data.

In some embodiments, the first data (e.g., transaction data) may include one or more text threads including, for example, a variety of letters, numbers, characters, symbols, etc., that help to identify individual transactions. Such text threads may be unique to each associated user in terms of how the text threads are formatted.

In block 104, the system (e.g., data contextualization system 408) may transform the first data into modified first data. Such transformation may include inserting a grammatical pattern into the text threads. The grammatical pattern may include character(s), such as letters or numbers, symbol(s), such as punctuation marks, mathematical symbols (e.g., an equals sign, greater-than sign, etc.), or combinations thereof. The transformation may further include inserting text phrase(s) into the text thread(s) adjacent to the grammatical pattern. An example of such data transformation is shown in Table 1, below, where (1) shows an original transaction text thread that might be included as part of the first data, and (2) shows how the original transaction text thread might be modified.

TABLE 1

| | |
|---|---|
| (1) | PAYPAL PYMNT 1234 TO ROKU |
| (2) | PAYPAL PYMNT 1234 TO ROKU=>ROKU//PAYPAL//Advertising |

In the above example, the original transaction text thread is transformed into a modified text thread by inserting the grammatical pattern “=>” into the original text thread, and inserting the text phrase(s) “ROKU//PAYPAL//Advertising” adjacent to the grammatical pattern.

It should be understood that the system may transform the first data into modified first data using a variety of different methods, such as, for example, implementing one or more natural language formats (e.g., ‘The counterparty is ROKU, the category is Advertising’) or a machine-readable standard such as JSON (e.g., ‘{“counterparty”: “ROKU”, “category”: “Advertising”}’).

In block 106, the system (e.g., data contextualization system 408) may train a first language model to identify one or more first features from the modified first data to create a trained first language model. The first feature(s) may include a category (e.g., corresponding to the transaction type), a counterparty (e.g., an end payee), a payment channel (e.g., an intermediary payee), or combinations thereof. In the above example, the model may be trained to identify and output “advertising” as the category, “Roku” as the counterparty, and “PayPal” as the payment channel based on these text phrases being placed adjacent to the grammatical pattern “=>.”

In block 108, the system (e.g., data contextualization system 408) may receive second data. In some embodiments, second data, and the process by which the system may receive second data, may be similar to first data, as described above in block 102. In some embodiments, however, second data may include transaction data received by the system after the language model has been trained, as discussed above, to achieve a desired threshold accuracy level.

In block 110, the system (e.g., data contextualization system 408) may transform the second data into modified second data by inserting the grammatical pattern into the second data's text thread(s). This insertion may be the same as or similar to that described above with respect to the first data. An example of such data transformation is shown in Table 2, below, where (1) shows an original transaction text thread that might be included as part of the second data, and (2) shows how the original transaction text thread might be modified.

TABLE 2

| | |
|---|---|
| (1) | WIRE 1234 TO USPS |
| (2) | WIRE 1234 TO USPS=> |

In the above example, the original transaction text thread is transformed into a modified text thread by inserting the grammatical pattern “=>” into the original text thread, specifically at the end of the text thread. By inserting this grammatical pattern, the trained language model may then identify the first feature(s) associated with this particular text thread, as further discussed below.

In block 112, the system (e.g., data contextualization system 408) may identify, via the trained first language model, the first feature(s) from a first portion of the modified second data. In the above example, the trained model may identify and output “logistics” as the category, “USPS” as the counterparty, and “Wire” as the payment channel based on the model having been trained to identify these features based on placement of the grammatical pattern.

As further discussed below, the system may be configured to utilize a semantic aggregator and/or a statistical aggregator depending on whether the trained first language model is able to successfully identify the first feature(s) in each transaction text thread that the system receives as part of the second data. When the trained first language model is able to successfully identify the first feature(s) in a transaction text thread, the system utilizes a semantic aggregator to further analyze the data, while when the trained first language model is unable to successfully identify the first feature(s), the system utilizes a statistical aggregator to further analyze the data.

In block 114, responsive to the trained first language model identifying the first feature(s) in the first portion (e.g., the entirety of, or a fraction thereof) of the modified second data, the system (e.g., data contextualization system 408) may dynamically map the first portion of the modified second data to one or more first categories. In some embodiments, this dynamic mapping may include aggregating each transaction text thread into a line item, such as a Profit and Loss Statement (P&L) category (e.g., Sales, Payroll, Logistics, Tax Payment, etc.). Such semantic aggregation can then be applied to generate a user- or customer-specific data report, as further discussed below.

In block 116, the system (e.g., data contextualization system 408) may generate a first customized report based on one or more of the modified second data, the first feature(s), the one or more first categories, or combinations thereof. In some embodiments, this user- or customer-specific report may be presented to the associated user or customer via a graphical user interface (GUI), such as via a web or mobile application. The associated user or customer may be able to view and interact with the report, for example via an account, such that the user can understand its cash inflows and outflows, as well as other financial outlooks and scenarios, based on a variety of factors, such as date, season, time period, merchant, transaction type, P&L category, and the like.

In some embodiments, the customized report may include one or more graphics (e.g., images, charts, graphs, etc.) that may dynamically change in real-time as the system receives new data, as further discussed below. In some embodiments, the customized report may include one or more selectable user input objects (e.g., click buttons, drop-down menus, search boxes, etc.) configured such that a user can switch between various views within the report. For example, a user may select different time periods, dates, accounts, etc., such that the data shown within the report changes to provide the user with different snapshots. In some embodiments, the system may modify or re-format various graphics and/or text displayed within the report based on a user's selection of the one or more selectable user input objects. For example, the system may modify the orientation or order of different graphics and/or text such that they are shown in a certain order within the report.

In some embodiments, the system may generate the customized report in response to receiving a request to generate the customized report. For example, the system may receive such a request from a user device (e.g., user device 402) and/or via an API. In some embodiments, the system may transmit the generated report to a display device (e.g., user device 402) over a network (e.g., network 406).

Turning to FIG. 1B, in block 118, the system (e.g., data contextualization system 408) may determine whether the trained first language model identifies the first feature(s) from a second portion of the modified second data. For example, if the “first portion” of first data, as discussed above in block 112, includes only a fraction or percentage of the first data, the system may be configured to evaluate any remaining fraction or percentage of the first data to determine whether the trained first language model was able to successfully identify the first feature(s) in that remaining portion.

In block 120, responsive to the trained first language model identifying the first feature(s) from the second portion of the modified second data, the system (e.g., data contextualization system 408) may dynamically map the second portion of the modified second data to the one or more first categories. This step may be the same as or similar to block 114, discussed above.

In block 122, further responsive to the trained first language model identifying the first feature(s) from the second portion of the modified second data, the system (e.g., data contextualization system 408) may calculate one or more first statistical metrics associated with a third portion of the modified second data (e.g., a fraction or percentage of data remaining after the first and second portions). The third portion may include a series of text threads from which the trained first language model was unable to identify the first feature(s), as discussed above. For example, the trained first language model may be configured to output a result of “null” rather than making an educated, yet potentially incorrect, guess at identifying the first feature(s). In such embodiments, the system may utilize a statistical aggregator to further analyze the data using statistical features, such as recurrence and correlation.

In some embodiments, calculating the first statistical metric(s) may include transforming the third portion of the modified second data into a frequency space via a Fourier Transformation. In some embodiments, the first statistical metric(s) may include recurring inflows, non-recurring inflows, recurring outflows, non-recurring outflows, or combinations thereof.

In block 124, the system (e.g., data contextualization system 408) may generate a second customized report based on one or more of the modified second data, the first feature(s), the one or more first categories, the first statistical metric(s), or combinations thereof. This step may be the same as or similar to block 116, discussed above, except that the second customized report may be further based on the statistical metric(s) calculated as part of the statistical aggregation.

In block 126, responsive to the trained first language model failing to identify the first feature(s) from the second portion of the modified second data, the system (e.g., data contextualization system 408) may calculate the first statistical metric(s) associated with the second portion of the modified second data. This step may be the same as or similar to block 122, discussed above.

In block 128, further responsive to the trained first language model failing to identify the first feature(s) from the second portion of the modified second data, the system (e.g., data contextualization system 408) may dynamically map the third portion of the modified second data to the one or more first categories. This step may be the same as or similar to block 120, discussed above.

In some embodiments, the system may continuously receive new data, such as in real-time via connections with users' accounts, as discussed above. As new data is received, the system may be configured to automatically transform each text thread within the new data, for example as discussed above in block 110, such that the trained first language model can attempt to identify the first feature(s) from the new modified data. As discussed above in FIGS. 1A-1B, the system may be configured to continuously monitor whether the trained first language model successfully identifies the first feature(s) from the newly modified text threads, and may respectively utilize the semantic and statistical aggregators when the trained first language model identifies or fails to identify the first feature(s) from new text threads. The system may continuously update the customized reports based on the newly received and aggregated data.

In some embodiments, the system may receive or retrieve additional data (e.g., different from the first and second data, discussed above), for example data associated with a business. The system may receive this data directly from users or businesses, or may retrieve this data via, e.g., a search engine, a web-scraper, etc., configured to find and collect such data. Collecting such data provides an added benefit of providing user- or business-specific contextual information that can help to eventually generate a more exhaustive and/or accurate customized report for each respective user or business, as further discussed below.

In some embodiments, the system may train a second language model to identify one or more second features associated with each respective user or business from the additional data. For example, the system may train a second language model to identify whether a certain business is the type of business that utilizes intermediary payees, or “middlemen,” in paying for products and/or services.

In some embodiments, the system may further train the first language model (as discussed in FIGS. 1A-1B) to identify the first feature(s) from the modified first data (block 106) based further on these second feature(s), for example, those associated with business context. An example of how these second feature(s) can be incorporated into the trained model's inferences is shown in Table 3, below, where (1) shows an original transaction text thread, (2) shows how the original transaction text thread might be modified, and (3) shows the output of the trained model.

TABLE 3

| | |
|---|---|
| (1) | MATTRESS FIRM IN DES:PAYABLES ID:1234 INDN:OLIVE |
| | WREN INC |
| (2) | MATTRESS FIRM IN DES:PAYABLES ID:1234 INDN:OLIVE |
| | WREN INC=> |
| (3) | MATTRESS FIRM//B2B Sale |

In the above example, the original transaction text thread is transformed into a modified text thread by inserting the grammatical pattern “=>” into the original text thread, specifically at the end of the text thread. In addition to training the model using the modified text thread, the system may also incorporate second feature(s) associated with the corresponding business into the training. For example, the system may incorporate the business owner name (e.g., “Olive Wren”), business context (e.g., “Olive Wren is a wholesaler that sells home goods to traditional retailers”), and a direction (e.g., “inflow”) into the model during training. This style of training may allow the model to output not only “MATTRESS FIRM” as the counterparty, but also “B2B Sale” as the category, given the trained model's understanding that transactions associated with this particular business could correspond to a business-to-business (B2B) sale given Olive Wren's business purpose. A benefit of this type of training is that the same transaction (e.g., listed as (1) in Table 3, above) may be categorized differently (e.g., “Purchase Refund”) for another business or individual. The business context allows the model to recognize this transaction as revenue.

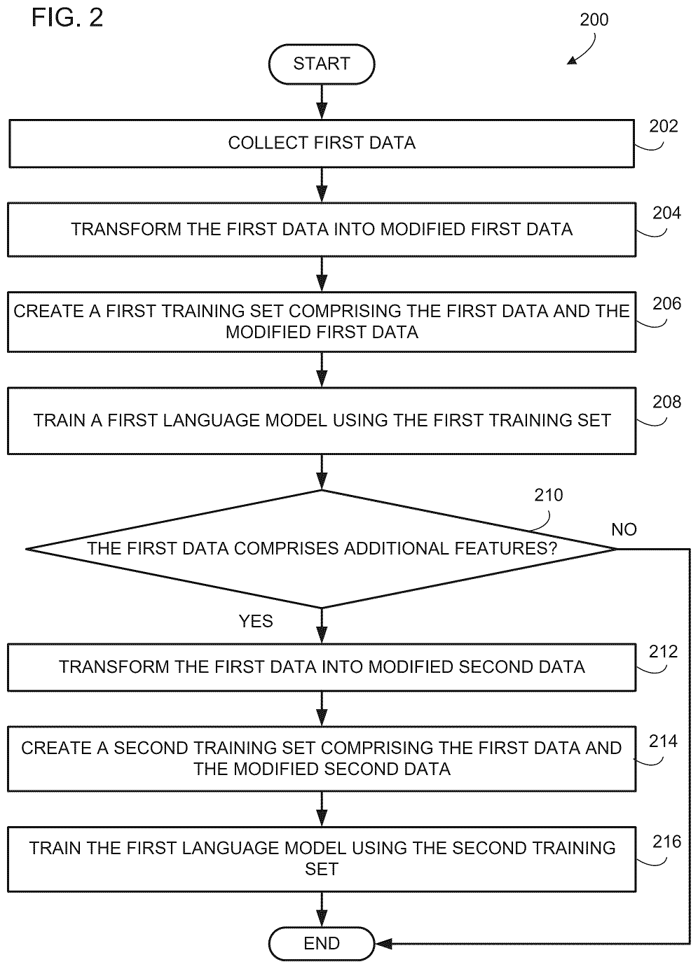

FIG. 2 is a flow diagram illustrating an exemplary method 200 for training a first language model to identify first feature(s) from modified first data, in accordance with certain embodiments of the disclosed technology. The steps of method 200 may be performed by one or more components of the system 400 (e.g., feature identification system 320 or web server 410 of data contextualization system 408, or user device 402), as described in more detail with respect to FIGS. 3 and 4. It should be understood that certain embodiments of the disclosed technology may omit one or more blocks as being optional.

In block 202, the system (e.g., data contextualization system 408) may collect first data including text thread(s). This step may be the same as or similar to block 102, discussed above with respect to FIG. 1A.

In block 204, the system (e.g., data contextualization system 408) may transform the first data by inserting a grammatical pattern into the text thread(s), and inserting first text phrase(s) into the text thread(s) adjacent to the grammatical pattern. This step may be the same as or similar to block 104, as discussed above with respect to FIG. 1A.

In block 206, the system (e.g., data contextualization system 408) may create a first training set including the first data and the modified first data. For example, the first training set may include one or more original transaction text threads, each with a respective modified text thread, an example of which is shown in Table 1, above. Another example is shown below in Table 4, where (1) shows an original transaction text thread that might be included as part of the first data, and (2) shows how the original transaction text thread might be modified.

TABLE 4

| | |
|---|---|
| (1) | PAYPAL INST XFER 230611 PP ROKU |
| (2) | PAYPAL INST XFER 230611 PP ROKU=>PAYPAL |

In the above example, the original transaction text thread is transformed into a modified text thread by inserting the grammatical pattern “=>” into the original text thread, and inserting the text phrase “PAYPAL” adjacent to the grammatical pattern.

In block 208, the system (e.g., data contextualization system 408) may train the first language model using the first training set. As discussed herein, for example, the system may train the first language model to identify first feature(s) from a modified text thread based on identifying the inserted grammatical pattern along with the text phrase(s) inserted adjacent to the grammatical pattern.

In block 210, the system (e.g., data contextualization system 408) may determine whether the first data comprises one or more additional features. For example, the system may determine whether the original transaction text thread(s) included in the first data include additional first feature(s) that, if identified by the trained language model, would help to increase the accuracy and efficiency of the model, as further discussed below.

In block 212, responsive to determining the first data comprises additional feature(s), the system (e.g., data contextualization system 408) may transform the first data into modified second data by inserting the grammatical pattern into the text thread(s), and inserting second text phrase(s) into the text thread(s) adjacent to the grammatical pattern. Table 5, below, provides an example of how the system may transform the first data into modified second data, where (1) shows the same original transaction text thread as shown in Table 4, above, and (2) shows how the original transaction text thread might be differently modified.

TABLE 5

| | |
|---|---|
| (1) | PAYPAL INST XFER 230611 PP ROKU |
| (2) | PAYPAL INST XFER 230611 PP ROKU=>ROKU |

In the above example, the original transaction text thread is transformed into a second and different modified text thread by inserting the grammatical pattern “=>” into the original text thread, and inserting the text phrase “ROKU” adjacent to the grammatical pattern.

In block 214, the system (e.g., data contextualization system 408) may create a second training set including the first data and the modified second data. For example, the second training set may include one or more original transaction text threads, each with a respective modified text thread, an example of which is shown in Table 5, above.

In block 216, the system (e.g., data contextualization system 408) may train the first language model using the second training set. Transforming the first data in two iterations, as described above, for example, by inserting a first text phrase (e.g., “PAYPAL”) adjacent the grammatical pattern in a first training set and a second text phrase (e.g., “ROKU”) adjacent the grammatical pattern in a second training set, provides an advantage of further fine-tuning the language model. In the example above, following training the first language model using the first training set, the model may be able to identify an intermediary payee, but may fail to identify a counterparty, or final payee. Thus, by fine-tuning the model using a second training set, the model may be iteratively trained to identify both the intermediary payee and the counterparty. In some embodiments, where the model is further trained using additional data (e.g., data associated with a business), as discussed above, the model may be able to identify when it is more likely that a text thread will include both an intermediary payee and a counterparty by understanding when a certain business is more likely to involve an intermediary payee in the payment of goods and/or services.

FIG. 3 is a block diagram of an example feature identification system 320 used to contextualize data, according to an example implementation of the disclosed technology. According to some embodiments, the user device 402 and web server 410, as depicted in FIG. 4 and described below, may have a similar structure and components that are similar to those described with respect to feature identification system 320 shown in FIG. 3. As shown, the feature identification system 320 may include a processor 310, an input/output (I/O) device 370, a memory 330 containing an operating system (OS) 340 and a program 350. In some embodiments, program 350 may include a language model (LM) 352 that may be trained, for example, to identify one or more features from modified data. In certain implementations, LM 352 may issue commands in response to processing an event, in accordance with a model that may be continuously or intermittently updated. Moreover, processor 310 may execute one or more programs (such as via a rules-based platform or the trained LM 352), that, when executed, perform functions related to disclosed embodiments.

In certain example implementations, the feature identification system 320 may be a single server or may be configured as a distributed computer system including multiple servers or computers that interoperate to perform one or more of the processes and functionalities associated with the disclosed embodiments. In some embodiments feature identification system 320 may be one or more servers from a serverless or scaling server system. In some embodiments, the feature identification system 320 may further include a peripheral interface, a transceiver, a mobile network interface in communication with the processor 310, a bus configured to facilitate communication between the various components of the feature identification system 320, and a power source configured to power one or more components of the feature identification system 320.

A peripheral interface, for example, may include the hardware, firmware and/or software that enable(s) communication with various peripheral devices, such as media drives (e.g., magnetic disk, solid state, or optical disk drives), other processing devices, or any other input source used in connection with the disclosed technology. In some embodiments, a peripheral interface may include a serial port, a parallel port, a general-purpose input and output (GPIO) port, a game port, a universal serial bus (USB), a micro-USB port, a high-definition multimedia interface (HDMI) port, a video port, an audio port, a Bluetooth™ port, a near-field communication (NFC) port, another like communication interface, or any combination thereof.

In some embodiments, a transceiver may be configured to communicate with compatible devices and ID tags when they are within a predetermined range. A transceiver may be compatible with one or more of: radio-frequency identification (RFID), NFC, Bluetooth™, low-energy Bluetooth™ (BLE), WiFi™, ZigBee™, ambient backscatter communications (ABC) protocols or similar technologies.

A mobile network interface may provide access to a cellular network, the Internet, or another wide-area or local area network. In some embodiments, a mobile network interface may include hardware, firmware, and/or software that allow(s) the processor(s) 310 to communicate with other devices via wired or wireless networks, whether local or wide area, private or public, as known in the art. A power source may be configured to provide an appropriate alternating current (AC) or direct current (DC) to power components.

The processor 310 may include one or more of a microprocessor, microcontroller, digital signal processor, co-processor or the like or combinations thereof capable of executing stored instructions and operating upon stored data. The memory 330 may include, in some implementations, one or more suitable types of memory (e.g. such as volatile or non-volatile memory, random access memory (RAM), read only memory (ROM), programmable read-only memory (PROM), erasable programmable read-only memory (EPROM), electrically erasable programmable read-only memory (EEPROM), magnetic disks, optical disks, floppy disks, hard disks, removable cartridges, flash memory, a redundant array of independent disks (RAID), and the like), for storing files in an operating system, application programs (including, for example, a web browser application, a widget or gadget engine, and or other applications, as necessary), executable instructions and data. In one embodiment, the processing techniques described herein may be implemented as a combination of executable instructions and data stored within the memory 330.

The processor 310 may be one or more known processing devices, such as, but not limited to, a microprocessor from the Core™ family manufactured by Intel™, the Ryzen™ family manufactured by AMD™, or a system-on-chip processor using an ARM™ or other similar architecture. The processor 310 may constitute a single core or multiple core processor that executes parallel processes simultaneously, a central processing unit (CPU), an accelerated processing unit (APU), a graphics processing unit (GPU), a microcontroller, a digital signal processor (DSP), a field-programmable gate array (FPGA), an application-specific integrated circuit (ASIC) or another type of processing component. For example, the processor 310 may be a single core processor that is configured with virtual processing technologies. In certain embodiments, the processor 310 may use logical processors to simultaneously execute and control multiple processes. The processor 310 may implement virtual machine (VM) technologies, or other similar known technologies to provide the ability to execute, control, run, manipulate, store, etc. multiple software processes, applications, programs, etc. One of ordinary skill in the art would understand that other types of processor arrangements could be implemented that provide for the capabilities disclosed herein.

In accordance with certain example implementations of the disclosed technology, the feature identification system 320 may include one or more storage devices configured to store information used by the processor 310 (or other components) to perform certain functions related to the disclosed embodiments. In one example, the feature identification system 320 may include the memory 330 that includes instructions to enable the processor 310 to execute one or more applications, such as server applications, network communication processes, and any other type of application or software known to be available on computer systems. Alternatively, the instructions, application programs, etc. may be stored in an external storage or available from a memory over a network. The one or more storage devices may be a volatile or non-volatile, magnetic, semiconductor, tape, optical, removable, non-removable, or other type of storage device or tangible computer-readable medium.

The feature identification system 320 may include a memory 330 that includes instructions that, when executed by the processor 310, perform one or more processes consistent with the functionalities disclosed herein. Methods, systems, and articles of manufacture consistent with disclosed embodiments are not limited to separate programs or computers configured to perform dedicated tasks. For example, the feature identification system 320 may include the memory 330 that may include one or more programs 350 to perform one or more functions of the disclosed embodiments. For example, in some embodiments, the feature identification system 320 may additionally manage dialogue and/or other interactions with the customer via a program 350.

The processor 310 may execute one or more programs 350 located remotely from the feature identification system 320. For example, the feature identification system 320 may access one or more remote programs that, when executed, perform functions related to disclosed embodiments.

The memory 330 may include one or more memory devices that store data and instructions used to perform one or more features of the disclosed embodiments. The memory 330 may also include any combination of one or more databases controlled by memory controller devices (e.g., server(s), etc.) or software, such as document management systems, Microsoft™ SQL databases, SharePoint™ databases, Oracle™ databases, Sybase™ databases, or other relational or non-relational databases. The memory 330 may include software components that, when executed by the processor 310, perform one or more processes consistent with the disclosed embodiments. In some embodiments, the memory 330 may include a database 360 for storing related data to enable the feature identification system 320 to perform one or more of the processes and functionalities associated with the disclosed embodiments.

The database 360 may include stored data relating to status data (e.g., average session duration data, location data, idle time between sessions, and/or average idle time between sessions) and historical status data. According to some embodiments, the functions provided by the database 360 may also be provided by a database that is external to the feature identification system 320, such as the database 416 as shown in FIG. 4.

The feature identification system 320 may also be communicatively connected to one or more memory devices (e.g., databases) locally or through a network. The remote memory devices may be configured to store information and may be accessed and/or managed by the feature identification system 320. By way of example, the remote memory devices may be document management systems, Microsoft™ SQL database, SharePoint™ databases, Oracle™ databases, Sybase™ databases, or other relational or non-relational databases. Systems and methods consistent with disclosed embodiments, however, are not limited to separate databases or even to the use of a database.

The feature identification system 320 may also include one or more I/O devices 370 that may comprise one or more interfaces for receiving signals or input from devices and providing signals or output to one or more devices that allow data to be received and/or transmitted by the feature identification system 320. For example, the feature identification system 320 may include interface components, which may provide interfaces to one or more input devices, such as one or more keyboards, mouse devices, touch screens, track pads, trackballs, scroll wheels, digital cameras, microphones, sensors, and the like, that enable the feature identification system 320 to receive data from a user (such as, for example, via the user device 402).

In examples of the disclosed technology, the feature identification system 320 may include any number of hardware and/or software applications that are executed to facilitate any of the operations. The one or more I/O interfaces may be utilized to receive or collect data and/or user instructions from a wide variety of input devices. Received data may be processed by one or more computer processors as desired in various implementations of the disclosed technology and/or stored in one or more memory devices.

The feature identification system 320 may contain programs that train, implement, store, receive, retrieve, and/or transmit one or more machine learning models (e.g., LM 352). Machine learning models may include a neural network model, a large neural network, a large language model (LLM), a generative adversarial model (GAN), a recurrent neural network (RNN) model, a deep learning model (e.g., a long short-term memory (LSTM) model), a random forest model, a convolutional neural network (CNN) model, a support vector machine (SVM) model, logistic regression, XGBoost, and/or another machine learning model. Models may include an ensemble model (e.g., a model comprised of a plurality of models). In some embodiments, training of a model may terminate when a training criterion is satisfied. Training criterion may include a number of epochs, a training time, a performance metric (e.g., an estimate of accuracy in reproducing test data), or the like. The feature identification system 320 may be configured to adjust model parameters during training. Model parameters may include weights, coefficients, offsets, or the like. Training may be supervised or unsupervised.

The feature identification system 320 may be configured to train machine learning models by optimizing model parameters and/or hyperparameters (hyperparameter tuning) using an optimization technique, consistent with disclosed embodiments. Hyperparameters may include training hyperparameters, which may affect how training of the model occurs, or architectural hyperparameters, which may affect the structure of the model. An optimization technique may include a grid search, a random search, a gaussian process, a Bayesian process, a Covariance Matrix Adaptation Evolution Strategy (CMA-ES), a derivative-based search, a stochastic hill-climb, a neighborhood search, an adaptive random search, or the like. The feature identification system 320 may be configured to optimize statistical models using known optimization techniques.

Furthermore, the feature identification system 320 may include programs configured to retrieve, store, and/or analyze properties of data models and datasets. For example, feature identification system 320 may include or be configured to implement one or more data-profiling models. A data-profiling model may include machine learning models and statistical models to determine the data schema and/or a statistical profile of a dataset (e.g., to profile a dataset), consistent with disclosed embodiments. A data-profiling model may include an RNN model, a CNN model, or other machine-learning model.

The feature identification system 320 may include algorithms to determine a data type, key-value pairs, row-column data structure, statistical distributions of information such as keys or values, or other property of a data schema may be configured to return a statistical profile of a dataset (e.g., using a data-profiling model). The feature identification system 320 may be configured to implement univariate and multivariate statistical methods. The feature identification system 320 may include a regression model, a Bayesian model, a statistical model, a linear discriminant analysis model, or other classification model configured to determine one or more descriptive metrics of a dataset. For example, feature identification system 320 may include algorithms to determine an average, a mean, a standard deviation, a quantile, a quartile, a probability distribution function, a range, a moment, a variance, a covariance, a covariance matrix, a dimension and/or dimensional relationship (e.g., as produced by dimensional analysis such as length, time, mass, etc.) or any other descriptive metric of a dataset.

The feature identification system 320 may be configured to return a statistical profile of a dataset (e.g., using a data-profiling model or other model). A statistical profile may include a plurality of descriptive metrics. For example, the statistical profile may include an average, a mean, a standard deviation, a range, a moment, a variance, a covariance, a covariance matrix, a similarity metric, or any other statistical metric of the selected dataset. In some embodiments, feature identification system 320 may be configured to generate a similarity metric representing a measure of similarity between data in a dataset. A similarity metric may be based on a correlation, covariance matrix, a variance, a frequency of overlapping values, or other measure of statistical similarity.

The feature identification system 320 may be configured to generate a similarity metric based on data model output, including data model output representing a property of the data model. For example, feature identification system 320 may be configured to generate a similarity metric based on activation function values, embedding layer structure and/or outputs, convolution results, entropy, loss functions, model training data, or other data model output). For example, a synthetic data model may produce first data model output based on a first dataset and a produce data model output based on a second dataset, and a similarity metric may be based on a measure of similarity between the first data model output and the second-data model output. In some embodiments, the similarity metric may be based on a correlation, a covariance, a mean, a regression result, or other similarity between a first data model output and a second data model output. Data model output may include any data model output as described herein or any other data model output (e.g., activation function values, entropy, loss functions, model training data, or other data model output). In some embodiments, the similarity metric may be based on data model output from a subset of model layers. For example, the similarity metric may be based on data model output from a model layer after model input layers or after model embedding layers. As another example, the similarity metric may be based on data model output from the last layer or layers of a model.

The feature identification system 320 may be configured to classify a dataset. Classifying a dataset may include determining whether a dataset is related to another datasets. Classifying a dataset may include clustering datasets and generating information indicating whether a dataset belongs to a cluster of datasets. In some embodiments, classifying a dataset may include generating data describing the dataset (e.g., a dataset index), including metadata, an indicator of whether data element includes actual data and/or synthetic data, a data schema, a statistical profile, a relationship between the test dataset and one or more reference datasets (e.g., node and edge data), and/or other descriptive information. Edge data may be based on a similarity metric. Edge data may indicate a similarity between datasets and/or a hierarchical relationship (e.g., a data lineage, a parent-child relationship). In some embodiments, classifying a dataset may include generating graphical data, such as anode diagram, a tree diagram, or a vector diagram of datasets. Classifying a dataset may include estimating a likelihood that a dataset relates to another dataset, the likelihood being based on the similarity metric.

The feature identification system 320 may include one or more data classification models to classify datasets based on the data schema, statistical profile, and/or edges. A data classification model may include a convolutional neural network, a random forest model, a recurrent neural network model, a support vector machine model, or another machine learning model. A data classification model may be configured to classify data elements as actual data, synthetic data, related data, or any other data category. In some embodiments, feature identification system 320 is configured to generate and/or train a classification model to classify a dataset, consistent with disclosed embodiments.

The feature identification system 320 may also contain one or more prediction models. Prediction models may include statistical algorithms that are used to determine the probability of an outcome, given a set amount of input data. For example, prediction models may include regression models that estimate the relationships among input and output variables. Prediction models may also sort elements of a dataset using one or more classifiers to determine the probability of a specific outcome. Prediction models may be parametric, non-parametric, and/or semi-parametric models.

In some examples, prediction models may cluster points of data in functional groups such as “random forests.” Random Forests may comprise combinations of decision tree predictors. (Decision trees may comprise a data structure mapping observations about something, in the “branch” of the tree, to conclusions about that thing's target value, in the “leaves” of the tree.) Each tree may depend on the values of a random vector sampled independently and with the same distribution for all trees in the forest. Prediction models may also include artificial neural networks. Artificial neural networks may model input/output relationships of variables and parameters by generating a number of interconnected nodes which contain an activation function. The activation function of a node may define a resulting output of that node given an argument or a set of arguments. Artificial neural networks may generate patterns to the network via an ‘input layer’, which communicates to one or more “hidden layers” where the system determines regressions via a weighted connections. Prediction models may additionally or alternatively include classification and regression trees, or other types of models known to those skilled in the art. To generate prediction models, the asset detection system may analyze information applying machine-learning methods.

While the feature identification system 320 has been described as one form for implementing the techniques described herein, other, functionally equivalent, techniques may be employed. For example, some or all of the functionality implemented via executable instructions may also be implemented using firmware and/or hardware devices such as application specific integrated circuits (ASICs), programmable logic arrays, state machines, etc. Furthermore, other implementations of the feature identification system 320 may include a greater or lesser number of components than those illustrated.

FIG. 4 is a block diagram of an example system that may be used to view and interact with data contextualization system 408, according to an example implementation of the disclosed technology. The components and arrangements shown in FIG. 4 are not intended to limit the disclosed embodiments as the components used to implement the disclosed processes and features may vary. As shown, data contextualization system 408 may interact with a user device 402 via a network 406. In certain example implementations, the data contextualization system 408 may include a local network 412, a feature identification system 320, a web server 410, and a database 416.

In some embodiments, a respective user may operate the user device 402. The user device 402 can include one or more of a mobile device, smart phone, general purpose computer, tablet computer, laptop computer, telephone, public switched telephone network (PSTN) landline, smart wearable device, voice command device, AR device, other mobile computing device, or any other device capable of communicating with the network 406 and ultimately communicating with one or more components of the data contextualization system 408. In some embodiments, the user device 402 may include or incorporate electronic communication devices for hearing or vision impaired users.

Users may include entities, businesses, or individuals such as, for example, subscribers, clients, prospective clients, or customers of an entity associated with an organization, such as individuals who have obtained, will obtain, or may obtain a product, service, or consultation from or conduct a transaction in relation to an entity associated with the data contextualization system 408. Users According to some embodiments, the user device 402 may include an environmental sensor for obtaining audio or visual data, such as a microphone and/or digital camera, a geographic location sensor for determining the location of the device, an input/output device such as a transceiver for sending and receiving data, a display for displaying digital images, one or more processors, and a memory in communication with the one or more processors.

The data contextualization system 408 may include programs (scripts, functions, algorithms) to configure data for visualizations and provide visualizations of datasets and data models on the user device 402. This may include programs to generate graphs and display graphs. The data contextualization system 408 may include programs to generate histograms, scatter plots, time series, or the like on the user device 402. The data contextualization system 408 may also be configured to display properties of data models and data model training results including, for example, architecture, loss functions, cross entropy, activation function values, embedding layer structure and/or outputs, convolution results, node outputs, or the like on the user device 402.

The network 406 may be of any suitable type, including individual connections via the internet such as cellular or WiFi™ networks. In some embodiments, the network 406 may connect terminals, services, and mobile devices using direct connections such as RFID, NFC, Bluetooth™, BLE, WiFi™, ZigBee™, ABC protocols, USB, WAN, or LAN. Because the information transmitted may be personal or confidential, security concerns may dictate one or more of these types of connections be encrypted or otherwise secured. In some embodiments, however, the information being transmitted may be less personal, and therefore the network connections may be selected for convenience over security.

The network 406 may include any type of computer networking arrangement used to exchange data. For example, the network 406 may be the Internet, a private data network, virtual private network (VPN) using a public network, and/or other suitable connection(s) that enable(s) components in the system 400 environment to send and receive information between the components of the system 400. The network 406 may also include a PSTN and/or a wireless network.

The data contextualization system 408 may be associated with and optionally controlled by one or more entities such as a business, corporation, individual, partnership, or any other entity that provides one or more of goods, services, and consultations to individuals such as customers. In some embodiments, the data contextualization system 408 may be controlled by a third party on behalf of another business, corporation, individual, partnership. The data contextualization system 408 may include one or more servers and computer systems for performing one or more functions associated with products and/or services that the organization provides.

Web server 410 may include a computer system configured to generate and provide one or more websites accessible to customers, as well as any other individuals involved in accessing data contextualization system 408's normal operations. Web server 410 may include a computer system configured to receive communications from user device 402 via for example, a mobile application, a chat program, an instant messaging program, a voice-to-text program, an SMS message, email, or any other type or format of written or electronic communication. Web server 410 may have one or more processors 422 and one or more web server databases 424, which may be any suitable repository of website data. Information stored in web server 410 may be accessed (e.g., retrieved, updated, and added to) via local network 412 and/or network 406 by one or more devices or systems of system 400. In some embodiments, web server 410 may host websites or applications that may be accessed by the user device 402. For example, web server 410 may host a financial service provider website that a user device may access by providing an attempted login that are authenticated by the data contextualization system 408. According to some embodiments, web server 410 may include software tools, similar to those described with respect to user device 402 above, that may allow web server 410 to obtain network identification data from user device 402. The web server may also be hosted by an online provider of website hosting, networking, cloud, or backup services, such as Microsoft Azure™ or Amazon Web Services™.

The local network 412 may include any type of computer networking arrangement used to exchange data in a localized area, such as WiFi™, Bluetooth™, Ethernet, and other suitable network connections that enable components of the data contextualization system 408 to interact with one another and to connect to the network 406 for interacting with components in the system 400 environment. In some embodiments, the local network 412 may include an interface for communicating with or linking to the network 406. In other embodiments, certain components of the data contextualization system 408 may communicate via the network 406, without a separate local network 412.

The data contextualization system 408 may be hosted in a cloud computing environment (not shown). The cloud computing environment may provide software, data access, data storage, and computation. Furthermore, the cloud computing environment may include resources such as applications (apps), VMs, virtualized storage (VS), or hypervisors (HYP). User device 402 may be able to access data contextualization system 408 using the cloud computing environment. User device 402 may be able to access data contextualization system 408 using specialized software. The cloud computing environment may eliminate the need to install specialized software on user device 402.

In accordance with certain example implementations of the disclosed technology, the data contextualization system 408 may include one or more computer systems configured to compile data from a plurality of sources via the feature identification system 320, web server 410, and/or the database 416. The data contextualization system 408 may correlate compiled data, analyze the compiled data, arrange the compiled data, generate derived data based on the compiled data, and store the compiled and derived data in a database such as the database 416. According to some embodiments, the database 416 may be a database associated with an organization and/or a related entity that stores a variety of information relating to customers, transactions, ATM, and business operations. The database 416 may also serve as a back-up storage device and may contain data and information that is also stored in, for example, database 360, as discussed with reference to FIG. 3.

Embodiments consistent with the present disclosure may include datasets. Datasets may comprise actual data reflecting real-world conditions, events, and/or measurements. However, in some embodiments, disclosed systems and methods may fully or partially involve synthetic data (e.g., anonymized actual data or fake data). Datasets may involve numeric data, text data, and/or image data. For example, datasets may include transaction data, financial data, demographic data, public data, government data, environmental data, traffic data, network data, transcripts of video data, genomic data, proteomic data, and/or other data. Datasets of the embodiments may be in a variety of data formats including, but not limited to, PARQUET, AVRO, SQLITE, POSTGRESQL, MYSQL, ORACLE, HADOOP, CSV, JSON, PDF, JPG, BMP, and/or other data formats.

Datasets of disclosed embodiments may have a respective data schema (e.g., structure), including a data type, key-value pair, label, metadata, field, relationship, view, index, package, procedure, function, trigger, sequence, synonym, link, directory, queue, or the like. Datasets of the embodiments may contain foreign keys, for example, data elements that appear in multiple datasets and may be used to cross-reference data and determine relationships between datasets. Foreign keys may be unique (e.g., a personal identifier) or shared (e.g., a postal code). Datasets of the embodiments may be “clustered,” for example, a group of datasets may share common features, such as overlapping data, shared statistical properties, or the like. Clustered datasets may share hierarchical relationships (e.g., data lineage).

### Example Use Case

The following example use case describes an example of a typical user flow pattern. This section is intended solely for explanatory purposes and not in limitation.

In one example, a system receives first data associated with a business, the first data including text thread(s), such as:
CHECKCARD 0211 ZIP.CO* LUVME HAIR HTTPSWWW.ZIP.NY
   The system may modify the above text tread by inserting a grammatical pattern into the text thread, and inserting a text phrase adjacent to the grammatical pattern, such as:
CHECKCARD 0211 ZIP.CO* LUVME HAIR HTTPSWWW.ZIP.NY$$$LUVME HAIR//Invoice Payment
   where “$$$” is the grammatical pattern, and “LUVME HAIR//Invoice Payment” is the text phrase. The system may use this modified text thread, as well as a plurality of additional modified text threads, to generate modified first data. The system may then train a language model using this modified data set to generate a trained language model capable of identifying certain features, such as a category and counterparty, from modified data threads. In the above example, “LUVME HAIR” is the counterparty, and “Invoice Payment” the category.

Once the model has been initially trained, the system may receive new data, and may modify this new data by inserting the same grammatical pattern (e.g., “$$$”) into the new text threads, but without inserting the text phrase as it did during the training step above. For example, the system may receive new data including the following text thread:
PMNT SENT 0731 FACEBOOK VISA DIRECT CA CKCD 4592 XXXXXXX44609
   and may transform the new text thread as follows:
PMNT SENT 0731 FACEBOOK VISA DIRECT CA CKCD 4592 XXXXXXX44609$$$

The trained language model may be able to analyze the above modified text thread to successfully identify “FACEBOOK” as the counterparty of the transaction, and “Advertising Spend” as the category. Once the trained language model has identified “FACEBOOK” as the counterparty of the transaction, and “Advertising Spend” as the category, the system may dynamically map the transaction data to one or more categories, such as P&L categories, and may generate a customized financial report for the associated business based on this data, as well as other data associated with the business.

In some examples, disclosed systems or methods may involve one or more of the following clauses:

Clause 1: A system comprising: one or more processors; and a memory in communication with the one or more processors and storing instructions that, when executed by the one or more processors, are configured to cause the system to: receive first data comprising one or more first text threads; transform the first data into modified first data by: inserting a grammatical pattern into the one or more first text threads; and inserting one or more text phrases into the one or more first text threads adjacent to the grammatical pattern; train a first language model to identify one or more first features from the modified first data to create a trained first language model; receive second data comprising one or more second text threads; transform the second data into modified second data by inserting the grammatical pattern into the one or more second text threads; identify, via the trained first language model, the one or more first features from a first portion of the modified second data; dynamically map the first portion of the modified second data to one or more first categories; and generate a first customized report based on one or more of the modified second data, the one or more first features, the one or more first categories, or combinations thereof.

Clause 2: The system of clause 1, wherein the instructions are further configured to cause the system to: determine whether the trained first language model identifies the one or more first features from a second portion of the modified second data; responsive to determining the trained first language model identifies the one or more first features from the second portion of the modified second data: dynamically map the second portion of the modified second data to the one or more first categories; and calculate one or more first statistical metrics associated with a third portion of the modified second data; responsive to determining the trained first language model fails to identify the one or more first features from the second portion of the modified second data: calculate the one or more first statistical metrics associated with the second portion of the modified second data; and dynamically map the third portion of the modified second data to the one or more first categories; and generate a second customized report based on one or more of the modified second data, the one or more first features, the one or more first categories, the one or more first statistical metrics, or combinations thereof.

Clause 3: The system of clause 2, wherein calculating the one or more first statistical metrics comprises transforming the second or third portion of the modified second data into a frequency space via a Fourier Transformation.

Clause 4: The system of clause 2, wherein the one or more first statistical metrics comprise one or more of recurring inflows, non-recurring inflows, recurring outflows, non-recurring outflows, or combinations thereof.

Clause 5: The system of clause 2, wherein the instructions are further configured to cause the system to: continuously: receive third data; transform the third data into modified third data; identify, via the trained first language model, the one or more first features from a fourth portion of the modified third data; dynamically map the fourth portion of the modified third data to the one or more first categories; automatically update the first customized report in real-time based on one or more of the modified third data, the one or more first features, the one or more first categories, or combinations thereof; determine whether the trained first language model identifies the one or more first features from a fifth portion of the modified third data; responsive to determining the trained first language model identifies the one or more first features from the fifth portion of the modified third data: dynamically map the fifth portion of the modified third data to the one or more first categories; and calculate the one or more first statistical metrics associated with a sixth portion of the modified third data; responsive to determining the trained first language model fails to identify the one or more first features from the fifth portion of the modified third data: calculate the one or more first statistical metrics associated with the fifth portion of the modified third data; and dynamically map the sixth portion of the modified third data to the one or more first categories; and automatically update the second customized report in real-time based on one or more of the modified third data, the one or more first features, the one or more first categories, the one or more first statistical metrics, or combinations thereof.

Clause 6: The system of clause 1, wherein the first and second data comprise transaction data.

Clause 7: The system of clause 1, wherein the grammatical pattern comprises one or more characters, one or more symbols, or both.

Clause 8: The system of clause 7, wherein the one or more symbols comprise an equals sign, a greater-than sign, or both.

Clause 9: The system of clause 1, wherein the one or more first features comprise one or more of a second category, a counterparty, a payment channel, or combinations thereof.

Clause 10: The system of clause 1, wherein the one or more first categories comprise Profit and Loss Statement (P&L) categories.

Clause 11: The system of clause 1, wherein the instructions are further configured to cause the system to: retrieve third data associated with a business; and train a second language model to identify one or more second features associated with the business from the third data, wherein training the first language model to identify the one or more first features from the modified first data is based on the one or more second features associated with the business, and wherein the first customized report is unique to the business.

Clause 12: The system of clause 11, wherein retrieving the third data is conducted via a search engine, a web-scraper, or both.

Clause 13: A system comprising: one or more processors; and a memory in communication with the one or more processors and storing instructions that, when executed by the one or more processors, are configured to cause the system to: receive first data; transform the first data into modified first data; identify, via a first language model, one or more first features from a first portion of the modified first data, wherein the first language model is trained to identify the one or more first features from the modified first data based on the modified first data comprising the first data and a grammatical pattern inserted into the first data; dynamically map the first portion of the modified first data to one or more first categories; and generate a first customized report based on one or more of the modified first data, the one or more first features, the one or more first categories, or combinations thereof.

Clause 14: The system of clause 13, wherein the instructions are further configured to cause the system to: determine whether the first language model identifies the one or more first features from a second portion of the modified first data; responsive to determining the first language model identifies the one or more first features from the second portion of the modified first data: dynamically map the second portion of the modified first data to the one or more first categories; and calculate one or more first statistical metrics associated with a third portion of the modified first data; responsive to determining the first language model fails to identify the one or more first features from the second portion of the modified first data: calculate the one or more first statistical metrics associated with the second portion of the modified first data; and dynamically map the third portion of the modified first data to the one or more first categories; and generate a second customized report based on one or more of the modified first data, the one or more first features, the one or more first categories, the one or more first statistical metrics, or combinations thereof.

Clause 15: The system of clause 13, wherein the instructions are further configured to cause the system to: retrieve second data; and identify, via a second language model, one or more second features from the second data, wherein the first language model is trained to identify the one or more first features from the modified first data based further on the one or more second features.

Clause 16: The system of clause 15, wherein the second data is associated with a business, and wherein the first customized report is unique to the business.

Clause 17: A method of training a first language model to identify one or more first features from modified first data, the method comprising: collecting first data comprising one or more text threads; transforming the first data into the modified first data by: inserting a grammatical pattern into the one or more text threads; and inserting one or more first text phrases into the one or more text threads adjacent to the grammatical pattern; creating a first training set comprising the first data and the modified first data; and training the first language model using the first training set.

Clause 18: The method of clause 17, further comprising: determining whether the first data comprises one or more additional features; responsive to determining the first data comprises the one or more additional features: transforming the first data into modified second data by: inserting the grammatical pattern into the one or more text threads; and inserting one or more second text phrases into the one or more text threads adjacent to the grammatical pattern; creating a second training set comprising the first data and the modified second data; and training the first language model using the second training set.

Clause 19: The method of clause 18, further comprising: collecting second data; identifying, via a second language model, one or more second features from the second data; creating a third training set comprising the second data and the one or more second features; and training the first language model using the third training set.

Clause 20: The method of clause 17, wherein the grammatical pattern comprises one or more characters, one or more symbols, or both.

The features and other aspects and principles of the disclosed embodiments may be implemented in various environments. Such environments and related applications may be specifically constructed for performing the various processes and operations of the disclosed embodiments or they may include a general-purpose computer or computing platform selectively activated or reconfigured by program code to provide the necessary functionality. Further, the processes disclosed herein may be implemented by a suitable combination of hardware, software, and/or firmware. For example, the disclosed embodiments may implement general purpose machines configured to execute software programs that perform processes consistent with the disclosed embodiments. Alternatively, the disclosed embodiments may implement a specialized apparatus or system configured to execute software programs that perform processes consistent with the disclosed embodiments. Furthermore, although some disclosed embodiments may be implemented by general purpose machines as computer processing instructions, all or a portion of the functionality of the disclosed embodiments may be implemented instead in dedicated electronics hardware.

The disclosed embodiments also relate to tangible and non-transitory computer readable media that include program instructions or program code that, when executed by one or more processors, perform one or more computer-implemented operations. The program instructions or program code may include specially designed and constructed instructions or code, and/or instructions and code well-known and available to those having ordinary skill in the computer software arts. For example, the disclosed embodiments may execute high level and/or low-level software instructions, such as machine code (e.g., such as that produced by a compiler) and/or high-level code that can be executed by a processor using an interpreter.

The technology disclosed herein typically involves a high-level design effort to construct a computational system that can appropriately process unpredictable data. Mathematical algorithms may be used as building blocks for a framework, however certain implementations of the system may autonomously learn their own operation parameters, achieving better results, higher accuracy, fewer errors, fewer crashes, and greater speed.

As used in this application, the terms “component,” “module,” “system,” “server,” “processor,” “memory,” and the like are intended to include one or more computer-related units, such as but not limited to hardware, firmware, a combination of hardware and software, software, or software in execution. For example, a component may be, but is not limited to being, a process running on a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Certain embodiments and implementations of the disclosed technology are described above with reference to block and flow diagrams of systems and methods and/or computer program products according to example embodiments or implementations of the disclosed technology. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, may be repeated, or may not necessarily need to be performed at all, according to some embodiments or implementations of the disclosed technology.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks.

As an example, embodiments or implementations of the disclosed technology may provide for a computer program product, including a computer-usable medium having a computer-readable program code or program instructions embodied therein, said computer-readable program code adapted to be executed to implement one or more functions specified in the flow diagram block or blocks. Likewise, the computer program instructions may be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

Certain implementations of the disclosed technology described above with reference to user devices may include mobile computing devices. Those skilled in the art recognize that there are several categories of mobile devices, generally known as portable computing devices that can run on batteries but are not usually classified as laptops. For example, mobile devices can include, but are not limited to portable computers, tablet PCs, internet tablets, PDAs, ultra-mobile PCs (UMPCs), wearable devices, and smart phones. Additionally, implementations of the disclosed technology can be utilized with internet of things (IoT) devices, smart televisions and media devices, appliances, automobiles, toys, and voice command devices, along with peripherals that interface with these devices.

In this description, numerous specific details have been set forth. It is to be understood, however, that implementations of the disclosed technology may be practiced without these specific details. In other instances, well-known methods, structures, and techniques have not been shown in detail in order not to obscure an understanding of this description. References to “one embodiment,” “an embodiment,” “some embodiments,” “example embodiment,” “various embodiments,” “one implementation,” “an implementation,” “example implementation,” “various implementations,” “some implementations,” etc., indicate that the implementation(s) of the disclosed technology so described may include a particular feature, structure, or characteristic, but not every implementation necessarily includes the particular feature, structure, or characteristic. Further, repeated use of the phrase “in one implementation” does not necessarily refer to the same implementation, although it may.

Throughout the specification and the claims, the following terms take at least the meanings explicitly associated herein, unless the context clearly dictates otherwise. The term “connected” means that one function, feature, structure, or characteristic is directly joined to or in communication with another function, feature, structure, or characteristic. The term “coupled” means that one function, feature, structure, or characteristic is directly or indirectly joined to or in communication with another function, feature, structure, or characteristic. The term “or” is intended to mean an inclusive “or.” Further, the terms “a,” “an,” and “the” are intended to mean one or more unless specified otherwise or clear from the context to be directed to a singular form. By “comprising” or “containing” or “including” is meant that at least the named element, or method step is present in article or method, but does not exclude the presence of other elements or method steps, even if the other such elements or method steps have the same function as what is named.

It is to be understood that the mention of one or more method steps does not preclude the presence of additional method steps or intervening method steps between those steps expressly identified. Similarly, it is also to be understood that the mention of one or more components in a device or system does not preclude the presence of additional components or intervening components between those components expressly identified.

Although embodiments are described herein with respect to systems or methods, it is contemplated that embodiments with identical or substantially similar features may alternatively be implemented as systems, methods and/or non-transitory computer-readable media.

As used herein, unless otherwise specified, the use of the ordinal adjectives “first,” “second,” “third,” etc., to describe a common object, merely indicates that different instances of like objects are being referred to, and is not intended to imply that the objects so described must be in a given sequence, either temporally, spatially, in ranking, or in any other manner.

While certain embodiments of this disclosure have been described in connection with what is presently considered to be the most practical and various embodiments, it is to be understood that this disclosure is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain embodiments of the technology and also to enable any person skilled in the art to practice certain embodiments of this technology, including making and using any apparatuses or systems and performing any incorporated methods. The patentable scope of certain embodiments of the technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A system comprising:
one or more processors; and
a memory in communication with the one or more processors and storing instructions that, when executed by the one or more processors, are configured to cause the system to:
receive first data comprising one or more first text threads;
transform the first data into modified first data by:
inserting a grammatical pattern into the one or more first text threads; and
inserting one or more text phrases into the one or more first text threads adjacent to the grammatical pattern;
train a first language model to identify one or more first features from the modified first data to create a trained first language model;
receive second data comprising one or more second text threads;
transform the second data into modified second data by inserting the grammatical pattern into the one or more second text threads;
identify, via the trained first language model, the one or more first features from a first portion of the modified second data;
dynamically map the first portion of the modified second data to one or more first categories; and
generate a first customized report based on one or more of the modified second data, the one or more first features, the one or more first categories, or combinations thereof.

2. The system of claim 1, wherein the instructions are further configured to cause the system to:
determine whether the trained first language model identifies the one or more first features from a second portion of the modified second data;
responsive to determining the trained first language model identifies the one or more first features from the second portion of the modified second data:
dynamically map the second portion of the modified second data to the one or more first categories; and
calculate one or more first statistical metrics associated with a third portion of the modified second data;
responsive to determining the trained first language model fails to identify the one or more first features from the second portion of the modified second data:
calculate the one or more first statistical metrics associated with the second portion of the modified second data; and
dynamically map the third portion of the modified second data to the one or more first categories; and
generate a second customized report based on one or more of the modified second data, the one or more first features, the one or more first categories, the one or more first statistical metrics, or combinations thereof.

3. The system of claim 2, wherein calculating the one or more first statistical metrics comprises transforming the second or third portion of the modified second data into a frequency space via a Fourier Transformation.

4. The system of claim 2, wherein the one or more first statistical metrics comprise one or more of recurring inflows, non-recurring inflows, recurring outflows, non-recurring outflows, or combinations thereof.

5. The system of claim 2, wherein the instructions are further configured to cause the system to:
continuously:
receive third data;
transform the third data into modified third data;
identify, via the trained first language model, the one or more first features from a fourth portion of the modified third data;
dynamically map the fourth portion of the modified third data to the one or more first categories;
automatically update the first customized report in real-time based on one or more of the modified third data, the one or more first features, the one or more first categories, or combinations thereof;
determine whether the trained first language model identifies the one or more first features from a fifth portion of the modified third data;
responsive to determining the trained first language model identifies the one or more first features from the fifth portion of the modified third data:
dynamically map the fifth portion of the modified third data to the one or more first categories; and
calculate the one or more first statistical metrics associated with a sixth portion of the modified third data;
responsive to determining the trained first language model fails to identify the one or more first features from the fifth portion of the modified third data:
calculate the one or more first statistical metrics associated with the fifth portion of the modified third data; and
dynamically map the sixth portion of the modified third data to the one or more first categories; and
automatically update the second customized report in real-time based on one or more of the modified third data, the one or more first features, the one or more first categories, the one or more first statistical metrics, or combinations thereof.

6. The system of claim 1, wherein the first and second data comprise transaction data.

7. The system of claim 1, wherein the grammatical pattern comprises one or more characters, one or more symbols, or both.

8. The system of claim 7, wherein the one or more symbols comprise an equals sign, a greater-than sign, or both.

9. The system of claim 1, wherein the one or more first features comprise one or more of a second category, a counterparty, a payment channel, or combinations thereof.

10. The system of claim 1, wherein the one or more first categories comprise Profit and Loss Statement (P&L) categories.

11. The system of claim 1, wherein the instructions are further configured to cause the system to:
retrieve third data associated with a business; and
train a second language model to identify one or more second features associated with the business from the third data,
wherein training the first language model to identify the one or more first features from the modified first data is based on the one or more second features associated with the business, and
wherein the first customized report is unique to the business.

12. The system of claim 11, wherein retrieving the third data is conducted via a search engine, a web-scraper, or both.

13. A system comprising:
one or more processors; and
a memory in communication with the one or more processors and storing instructions that, when executed by the one or more processors, are configured to cause the system to:
receive first data;
transform the first data into modified first data;
identify, via a first language model, one or more first features from a first portion of the modified first data, wherein the first language model is trained to identify the one or more first features from the modified first data based on the modified first data comprising the first data and a grammatical pattern inserted into the first data;
dynamically map the first portion of the modified first data to one or more first categories; and
generate a first customized report based on one or more of the modified first data, the one or more first features, the one or more first categories, or combinations thereof.

14. The system of claim 13, wherein the instructions are further configured to cause the system to:
determine whether the first language model identifies the one or more first features from a second portion of the modified first data;
responsive to determining the first language model identifies the one or more first features from the second portion of the modified first data:
dynamically map the second portion of the modified first data to the one or more first categories; and
calculate one or more first statistical metrics associated with a third portion of the modified first data;
responsive to determining the first language model fails to identify the one or more first features from the second portion of the modified first data:
calculate the one or more first statistical metrics associated with the second portion of the modified first data; and
dynamically map the third portion of the modified first data to the one or more first categories; and
generate a second customized report based on one or more of the modified first data, the one or more first features, the one or more first categories, the one or more first statistical metrics, or combinations thereof.

15. The system of claim 13, wherein the instructions are further configured to cause the system to:
retrieve second data; and
identify, via a second language model, one or more second features from the second data,
wherein the first language model is trained to identify the one or more first features from the modified first data based further on the one or more second features.

16. The system of claim 15, wherein the second data is associated with a business, and wherein the first customized report is unique to the business.

17. A method of training a first language model to identify one or more first features from modified first data, the method comprising:
collecting first data comprising one or more text threads;
transforming the first data into the modified first data by:
inserting a grammatical pattern into the one or more text threads; and
inserting one or more first text phrases into the one or more text threads adjacent to the grammatical pattern;
creating a first training set comprising the first data and the modified first data; and
training the first language model using the first training set.

18. The method of claim 17, further comprising:
determining whether the first data comprises one or more additional features;
responsive to determining the first data comprises the one or more additional features:
transforming the first data into modified second data by:
inserting the grammatical pattern into the one or more text threads; and
inserting one or more second text phrases into the one or more text threads adjacent to the grammatical pattern;
creating a second training set comprising the first data and the modified second data; and
training the first language model using the second training set.

19. The method of claim 18, further comprising:
collecting second data;
identifying, via a second language model, one or more second features from the second data;
creating a third training set comprising the second data and the one or more second features; and
training the first language model using the third training set.

20. The method of claim 17, wherein the grammatical pattern comprises one or more characters, one or more symbols, or both.
